(19) United States
(12) Patent Application Publication
(10) Pub. No.: US 2004/0153421 A1
(43) Pub. Date: Aug. 5, 2004

(54) System and method for biometric authorization of age-restricted transactions conducted at an unattended device

(76) Inventor: Timothy Robinson, Herndon, VA (US)

Correspondence Address: ROBERTS ABOKHAIR & MARDULA, SUITE 1000, 11800 SUNRISE VALLEY DRIVE, RESTON, VA, 20191, US

(21) Appl. No.: 10/625,045

(22) Filed: Jul. 23, 2003

Related U.S. Application Data
(63) Continuation-in-part of application No. 10/369,235, filed on Feb. 19, 2003.
Application No. 10/369,235 is a continuation-in-part of application No. 10/251,305, filed on Sep. 20, 2002.
(60) Provisional application No. 60/324,229, filed on Sep. 21, 2001.

(51) Int. Cl. G06F 17/60

(52) U.S. Cl. 705/75

(57) ABSTRACT

The present invention provides a reliable system and method that conducts age verifications of individuals at unattended devices for access to age-restricted areas, goods, and services. A biometric read (such as a fingerprint) is used to verify age and does not require the use of any age-verifying token.

### CROSS REFERENCE TO RELATED APPLICATIONS

This application is a continuation-in-part of application Ser. No. 10/369,235, filed Feb. 19, 2003, pending, which is a continuation-in-part of application Ser. No. 10/251,305, filed Sep. 20, 2002, pending, which claims domestic priority from provisional application no. 60/324,229, filed Sep. 21, 2001. The Ser. No. 10/369,235 application and the Ser. No. 10/251,305 application are incorporated by reference herein, in their entireties, for all purposes.

### INTRODUCTION

This application relates generally to the accessing of age-restricted goods, services and/or areas at an unattended device. More particularly, the present invention relates to a tokenless system and method for age verification transactions in a system for accessing age-restricted goods, services and/or areas at an unattended device using a biometric for verification of a presenter's age and identity.

### BACKGROUND OF THE INVENTION

In recent years, tightened government control over the sale of age-restricted goods, such as cigarettes and alcohol, has prevented these goods from being commonly sold in any form of automated vending. Although vending machines selling age-restricted products such as cigarettes were once popular, issues tied to an underage individual's ease in accessing the goods sold in these machines halted their production and use.

Various inventions exist in the field of age-restricted vending that attempt to solve the problems of the previous vending machines that sold age-restricted goods. Several such machines require consumers to swipe a driver's license through a scanning device connected to a vending machine. The vending machine then determines from the data received during the data read of the customer's driver's license whether or not the customer is of legal age to purchase the goods sold in that machine. The problem with this type of age-controlled vending is that an underage individual could steal or borrow another person's ID who is of age to purchase the goods and then use that ID to identify themselves as a consumer of legal age to purchase age-restricted goods. Therefore, although the system poses a more secure method of vending age-restricted goods than previous methods, the token-based age verification poses vulnerability in the system. Token based referring to any physical article used to verify identity, such as a driver's license or passport. One known derivation of the above token-based inventions uses limited biometrics in conjunction with a token. However, the transaction is still token-based since the token is required at each age-restricted access. A consumer using a token-based system would have to present at least the token related to the system, which means that consumer must carry the token on their person. If the token is not universal to all transaction systems the consumer uses, the consumer must then carry multiple tokens. Thus, carrying multiple tokens for access to various token-based systems adds an inconvenience factor and potentially adds a security risk, since the tokens are not attached to their person and may be easily lost or stolen.

Another known form of age verification that has been incorporated into an age-restricted vending device comprises a potential customer swiping a credit card for both payment and age verification. This method poses problems similar to those mentioned earlier since the age verifications performed at the machine are token-based. This vending machine still bears the problem of potentially selling age-restricted goods to consumers who are not of age but are only presenting either a stolen or borrowed credit card. Additionally, this particular invention not only assumes the vending machine comprises connections to the credit network, but it also assumes the consumer wants to pay for their purchase via credit card.

What is needed is a system and method that links an individual's biometric with the individual's age verifying information and which allows the individual to verify their age at any participating unattended point of age-restricted access for access to goods, services and/or areas by presenting at least one registered biometric.

### SUMMARY OF THE INVENTION

One aspect of the current invention is that it provides a reliable system and method that conducts age verifications of individuals at unattended devices for access to age-restricted areas, goods, and services.

In one embodiment the present invention offers a convenient and secure way to conduct an age verification in an age-restricted transaction with the use of a biometric read (such as a fingerprint) and without the use of any age-verifying token.

In another embodiment the present invention provides a system and method to help deter individuals from presenting fraudulent identification during an age-verification transaction at an unattended device.

In another embodiment the present invention creates a system that allows an individual to present age verifying and identity verifying documents once upon enrollment and then to use a biometric sample to verify their age and verify their identity thereafter at participating devices in the system.

In still another embodiment, the present invention allows individuals to register financial account information with the system and authorize financial transaction payment by presenting their registered biometric sample at unattended age verification stations comprising connections to unattended, age-restricted point of sale devices.

In a particular embodiment the present invention uses at least one database that stores information concerning a plurality of age presenters (hereon presenters). Presenters are individuals seeking access to age-restricted goods, areas, and/or services at an unattended age verification station. The present invention also uses at least one unattended age verification station that has connections to necessary peripherals for biometric scanning and has communication lines for connection to at least one database wherein the presenter's information is stored. In an embodiment where financial transactions are conducted at the age verification station, the station additionally has connections to necessary peripherals for financial settlement.

To register in the system, an individual presents at least one biometric sample as well as an identity-verifying and age-verifying information, which may come from the same source. A biometric sample may be, for example and without limitation, a fingerprint scan, an iris scan, a retinal scan, a face geometric scan, or a voice print. The identity-verifying information may be, for example and without limitation, a name, a home address, a telephone number, and/or a government ID number and state of issue. The age-verifying information may be, for example and without limitation, date of birth which is verified with presentment of a government or state issued document. In yet another embodiment of the system, the individual also registers with the system a system identification number (SID) that is used in conjunction with their biometric scan for age verification. In an additional embodiment, the age presenter also registers financial information in the system. This financial information may be, for example and without limitation, checking account data, credit account data, debit account data, and/or value account data that will enable them to conduct financial transactions with their registered financial account(s) using biometric authentication.

Presenter information entered into the system for initial age and identity verification is reviewed and verified by a verifier, an individual who is registered to conduct presenter enrollment. The verifier might verify the presenter's information by pressing a key on the enrollment device's keypad or scanning their biometric.

An individual who has already registered in the system may verify their age at any participating unattended age verification station by entering a biometric sample. This information is sent to the database where the individual's system record is stored, and it is used to find the individual's system record, which contains identity verifying and age verifying information. Once the individual's system record is found and the biometric sample is confirmed as matching the biometric record stored in the individual's system record, the individual's age information stored in that system record is evaluated to determine whether or not it is at or above the level for age verification approval. If the individual's age is at or above the age verification level, the individual's age is verified, and the individual's requested transaction involving age-restricted access is approved.

### BRIEF SUMMARY OF THE DRAWINGS

Additional objects and advantages of the present invention will be apparent in the following detailed description read in conjunction with the accompanying drawing figures.

FIG. 1 illustrates a general architecture overview of a system for age-restricted transactions conducted at an unattended age verification station according to an embodiment of the present invention.

FIG. 2 illustrates a flowchart of a process for enrollment into the system for age-restricted transactions conducted at an unattended age verification station according to an embodiment of the present invention.

FIG. 3 illustrates a flowchart of a process for an age-restricted transaction conducted at an unattended age verification station according to an embodiment of the present invention.

FIG. 4 illustrates a flowchart of a process for an age-restricted transaction conducted at an unattended age verification station using local biometric matching according to an embodiment of the present invention.

FIG. 5 illustrates a flowchart of a process for an age-restricted transaction conducted at an unattended age verification station using local biometric matching according to an embodiment of the present invention.

FIG. 6 illustrates a flowchart showing another example of using local biometric matching according to an embodiment of the present invention.

FIG. 7 illustrates showing still another example of using local biometric matching according to an embodiment of the present invention.

### DETAILED DESCRIPTION OF THE INVENTION

As previously noted, the present invention encompasses a system and method for verifying an individual's age for an age-restricted transaction using a biometric sample at an unattended age verification station. Biometrics are unique physical or behavioral characteristics of an individual which can be measured and thus compared to accurately verify or identify an individual.

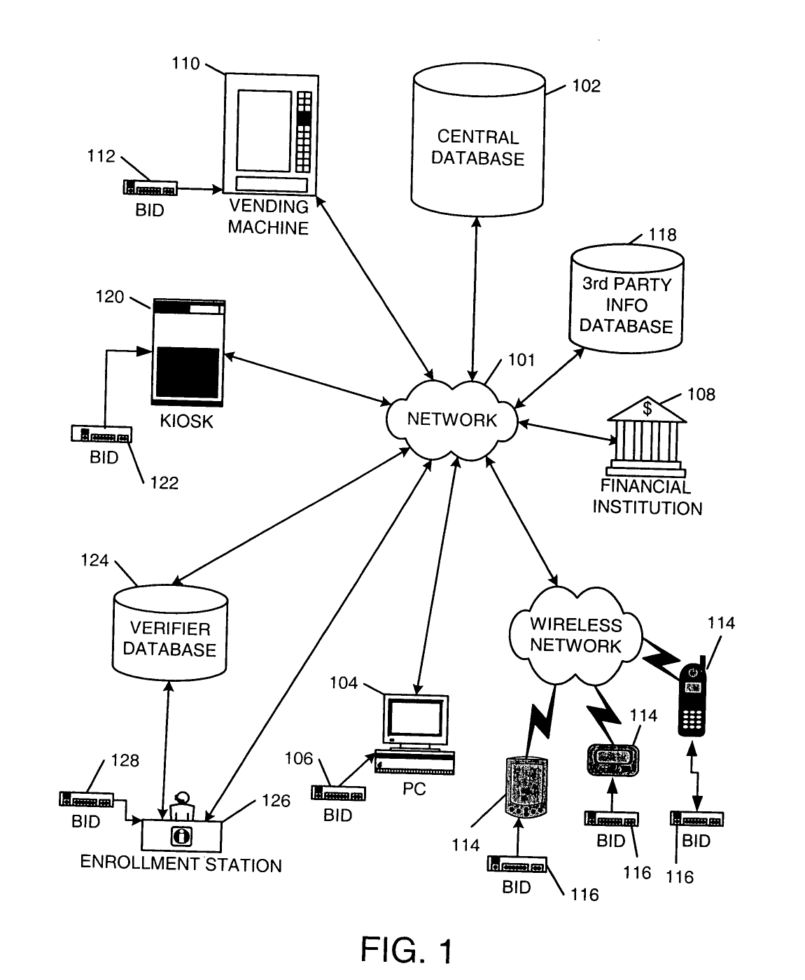

Referring to FIG. 1, a general architecture overview of a system for age-restricted transactions using biometric matching and conducted at an unattended age verification station is illustrated. Presenters are individuals who have enrolled in the system of the invention and who desire to acquire or purchase access to age-restricted goods, services and/or areas through the use of an unattended age verification station. Presenter records hold age verifying information, identity verifying information, and at least one biometric sample. The system includes a central database 102, wherein a presenter's information, authorized verifier information, and authorized age verification station information is stored. Various other records and databases may also be held in the system's central database. Additional embodiments of the invention allow presenter records and other system records to be stored in at least one verifier database 124 or in a combination of a central database and at least one verifier database.

Age verifying and identity verifying information includes information, such as but not limited to, a presenter's age and/or date of birth as indicated by an official identification document, government identification (ID) number and state of issue, home address, or a telephone number. In an additional embodiment of the invention, a presenter record also holds at least one a system identification code (SID). A presenter may choose this SID from any of the previously listed personal identification numbers. They may select their own SID, or they may choose from system suggested ID numbers. In yet an additional embodiment, presenter records also hold financial account information that allows them to pay for an age-restricted purchase with biometric authorization.

Verifiers are individuals designated to supervise and verify enrollment of presenters into the system of the invention. Verifier information stored at the system's central database includes identity verifying information pertaining to system operators who verify a presenter's enrollment into the system of the invention. Such information may include but is not limited to, at least one biometric scan, a system identification number, an address, a telephone number, and/or an employee identification number. In an additional embodiment, verifier information may be stored in stored in at least one verifier database 124 or in a combination of a central database and at least one verifier database.

An age verification station is any device or network of devices with connections to at least one biometric identification device (BID) configured to offer presenters access to age-restricted goods or services and which additionally comprises connections to at least one system database. By way of illustration and without limitation, an age verification station may simply be a vending machine with integrated or attached BID or may be a network of vending machines connected to a BID which is either integrated into one of the vending machines or integrated into a separate station which is linked to the vending machine network. Age verification station information comprises information useful in identifying an age verification station or specific devices used at that station within the system of the invention. Such information may include, but is not limited to, address of the station location, the terminal identification number (TID) of a device connected to the station, the manufacturer of the station equipment, and/or the station manager. Depending on the embodiment of the invention, the age verification station identification code (ID code) identifies the age verification station and indicates the age parameters by which to evaluate a presenter's age. The ID code may simply be the TID of at least one biometric device connected to the age verification station.

The invention is configured so that the central database 102 is connected to a network 101 such as but not limited to, the Internet. This network comprises connections to at least one unattended age verification station, such as but not limited to a vending machine 110 with connected biological identification device (BID) 112 and/or a kiosk 120 with connected BID 122. The vending machine 110 and the kiosk 120 are configured in any manner to allow access to and/or sell products, services, and/or access to age-restricted products/services without the aid of a human attendee. Examples of age-restricted products/services these unattended age verification stations provide access to include, but are not limited to, entrance into nightclubs or bars; cigarettes, cigars, and other tobacco related products; beer (cans, bottles or drafts), liquor (shots or mixed drinks) and other alcohol related products; adult media (magazines, books, CDs and DVDs); lottery tickets; movie tickets; and any combination of these examples. These unattended age verification stations may reside in various locations. For example, they may sit along side traditional vending machines, be incorporated into such vending machines, or they may be incorporated into a business such as an “unattended bouncer,” “unattended bartender” or “unattended cigarette girl” in a nightclub, bowling alley, or hotel.

The network also has connections to at least one enrollment station 126 with at least one BID 128. By way of illustration and without limitation, the enrollment station may be a register at a grocery store, a customer service desk at a grocery store, a customer service desk at a bank, and/or a customer service desk at a state Department of Motor Vehicles (DMV). In an additional embodiment, the station has connections to a local database and communicates with the system central database through the local database.

In an additional embodiment, the network also has connections to a computer (PC) 104 with connected BID 106 and a wireless device 114 with connected BID 116 to allow presenters to perform functions in the system such as pre-enrollment, enrollment, and record maintenance, all of which are discussed later in this application. The system is also connected to at least one third party information database 118 with which verifiers can conduct presenter identity checks, age checks, and/or financial account checks. For further information on how biometrically authorized financial transactions might be conducted within the system see utility application Ser. No. 10/251,305 filed by Tim Robinson on Sep. 21, 2002. The Ser. No. 10/251,305 application is incorporated by reference herein, in its entirety, for all purposes. The system additionally comprises connections to at least one financial institution 108 to allow presenters to perform financial transactions with their presenter system records.

To enroll into the system of the invention, a presenter presents identity verifying information and age-verifying information at a participating attended enrollment station 126 with BID 128. In an additional embodiment, the presenter may also enter a SID and/or financial account information.

Presenters interested in enrolling in the system further have the option to pre-enroll, that is provide a partial enrollment, by providing only a portion of the required enrollment information for the invention's services via a computer 104, a vending machine 110, a wireless device 114, a kiosk 120, or a verifier device 126 or 130, which is connected to a network preferably but without limitation the Internet, which is connected to the invention's central database 102. Pre-enrollment records are stored as partial records which a presenter cannot use to verify their age until the remainder of enrollment information is collected and verified by a registered verifier. Such partial records are marked pre-enrollment.

Pre-enrollments may be conducted at system devices with or without a BID. If a presenter pre-enrolls at a device in the system that does not have an attached BID, they may finalize enrollment at any participating device with an attached BID by selecting an option on the device nominated as “finish enrollment.” The device then prompts the presenter to enter a selection of pre-enrolled information and present at least one designated biometric for scanning. This information is sent to the central database to locate the presenter's partial record. If a partial record matching the presenter's entered pre-registered information is found, the biometric sample entered is stored in that presenter's record. If the presenter record is missing any information, the central database sends the presenter notice of information needed to complete the enrollment, the presenter and/or an enrollment verifier enter the requested information, and that information is sent to the central database and stored in the presenter's system record.

Alternate forms of pre-enrollment may include purchasing or acquiring at least one database of presenter information and registering that information with the invention's central database. Such database information could supply the system with various presenters' identity or age information. By way of illustration and not as a limitation, the central database operator might purchase driver's license data from a state or government database and use that information during presenter enrollment, wherein the information is checked when the presenter pre-enrolls, is checked during enrollment finalization wherein the presenter is seeking to complete their enrollment into the system, or is checked during a complete enrollment. The information could be easily entered into the central database so that when a presenter whose information was recorded in one of those purchased or acquired databases wants to pre-enroll or enroll in the system of the invention, some or all of that information contained within the purchased or acquired database may already be available within the system and may not need to be entered at the time of enrollment, thus saving time for the presenter and verifier during enrollment.

Age-restricted transactions are conducted within the system through a number of unattended devices including but not limited to a vending machine 110 with attached BID 112 or a kiosk 120 with attached BID 122.

Presenters manage their system records through a record management function that allows them to update personal or financial information registered in their system record. These changes may be conducted at any of the following: a PC 104, a vending machine 110, a wireless device 114, a kiosk 120, or any participating verifier's device 126.

The system is generally configured as an “open” system, which is defined for the purposes of this application as a system wherein all information entered into the system is transmitted to and stored in the system's central database. An open system allows system users to conduct enrollments and transactions at any station in the system, regardless of where the system user enrolled, because an open system shares all information stored in the system central database with all enrollment and transaction stations.

In an alternate embodiment, the system is configured as a “closed” system, meaning information entered into the system via a specific verifier device is transmitted to and stored in the verifier database and this information is only shared with age verification stations affiliated with the verifier database. This is referred to a “closed” system because age presenters enrolled in one verifier database must enroll in the database of each additional database wherein they would like to verify their age. Verifier databases in closed systems may query other databases, such as a central database or a third party database, for age presenter information verification. In an alternate embodiment of the closed system, information stored on a verifier database is additionally stored on the central database. Such an embodiment is useful for a reason such as, but without limitation, information protection in the event database information is lost.

In yet a further embodiment of the present invention, verification information is stored in select multiple verifier databases. In this embodiment, a system of select verifiers will have chosen whether or not to share system information with the invention's central database. Such a system is referred to as a “multi-verifier” system. This system allows a chain of verifiers owned by the same entity or linked in some other manner to share verification information obtained at at least one of the linked locations amongst themselves without sharing that information with all other non-designated verifiers registered in the system. Verification information in a multi-verifier system is stored in either the central database or at least one of the select verifier database in the verifier system. Information in such a system may be shared between verifier database and the central database freely or sharing may be monitored by rules set in the verifier databases, the central database, or both. By way of illustration and not as a limitation, one verifier might only want to share verification information with one of five verifiers in a multi-verifier system or all verifiers might not want to send or store verification transaction information to the central database.

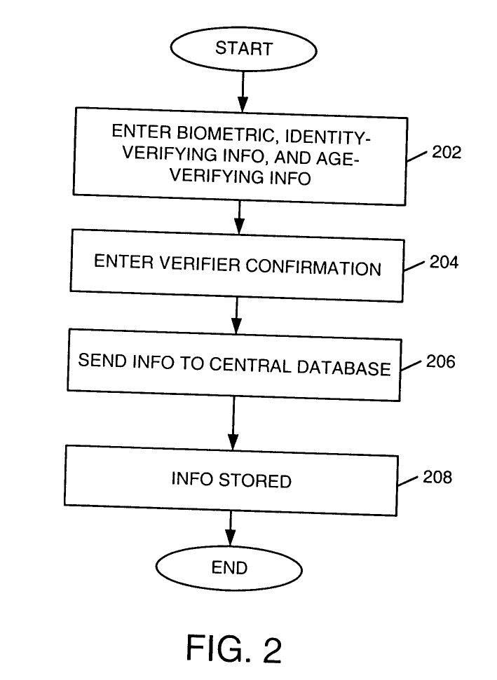

Referring to FIG. 2, a flowchart of an enrollment process according to an embodiment of the present invention is illustrated. The presenter is prompted to provide age verifying information, identity verifying information, and at least one biometric sample 202. In additional embodiments of the system, the presenter also provides financial information and/or at least one SID.

By way of illustration and not as a limitation, one way of presenting the age verification information during enrollment includes driver's license data being read from a magnetic stripe or bar code on the driver's license, from which date of birth information is pulled and used to calculate the presenter's age. Examples of suitable identity-verifying information are: a government ID number and state of issue, social security number, address, phone number, digital scans of information documents presented for identification, and other personal information about the enrolling presenter. This information may be card-swiped, scanned, hand-keyed, or entered by another means. In an additional embodiment, identity documents such as a driver's license or identification card are digitally imaged and stored in the respective presenter's record. Digitally imaging identity documents provides the system of the invention a security feature because it enables authorized individuals (such as verifiers and law enforcement) who challenge an age-restricted transaction verification to view the identifying documents a presenter used to enroll into the system.

An additional feature of the present invention is the availability of further verifying presenter's age verification information, identity verification information, or biometric information stored with at least one participating third party database. Further verifying age and/or identity information adds to the system's security but is not strictly required to practice the present invention. By way of illustration and not as a limitation, retrieving further verifying information from a third party database includes the device accessing the third party database for out-of-wallet information, such as where the presenter went to college and then asking the presenter questions related to that out-of-wallet information, such as “which college did you attend: a, b, or c?” Such information is commonly stored in credit databases as a result of student loan information.

Yet another embodiment of the invention comprises checking presenter age verification information against presenter age verification information that is already recorded in the central database as a result of the central database owner obtaining or purchasing information from private, public, or government databases. Examples of such information include, but are not limited to, driver's license data, employment data, and biometric data. All information obtained or purchased from such databases by the central database owner may be utilized for verification or confirmation of presenter information.

A presenter's biometric sample is entered via a biometric scanner. This sample is then translated to and stored in biometric template form. A biometric template is an alphanumerical summary of a biometric image that is determined via a mathematical formula and is typically used in biometric applications due to its smaller size and the current inability to reverse the template-generating mathematical formula to derive the original biometric image. Template forms of scanned biometrics are generally used in the present system of the invention for biometric comparisons. In an additional embodiment, the digital scan of the biometric is itself also stored in the central database. Such an embodiment that also stores the biometric digital scan is useful for reasons such as, but without limitation, biometric matching purposes, security procedures (in the case of an individual attempting to fraudulently access the system), or information protection in the event database information is lost or templates need to be re-constructed due to hardware revisions. In yet an additional embodiment, both the digital image of the biometric and the template are stored in a presenter's system record and either may be used for age verification purposes.

In an additional embodiment, the system is configured to allow a presenter to register more than one type of biometric sample or two or more of the same type of biometric during enrollment. For example, the invention's system may be configured to accept a fingerprint biometric along with a face scan biometric, or the system may be configured to allow the presenter to register finger scans from more than one finger. Storing a biometric template in the presenter's system record that includes data from more than one biometric sample type enables that presenter the convenience of presenting any one of the presenter's previously scanned biometrics for age verification, record access authorization, and/or funds transfer within the system of the invention. Such an embodiment could further allow the system to request that the presenter provide more than one biometric for age verification. In this embodiment, the system might randomly choose a biometric sample to use for matching purposes, might choose two or more biometric samples to use for matching purposes, or might choose to match all biometric samples entered by the presenter at the age verification station.

If the embodiment of the system requires the presenter to register a SID, the SID is used to help identify that presenter in the invention's system. A SID is not equivalent to a PIN used for financial ATM and debit transactions. Rather, the SID simplifies the verification of the biometric sample. The SID may be a unique number (a number with no chance of being honestly duplicated, e.g. social security number), reasonably unique number (a number with a statistically small chance of being duplicated, e.g. phone number plus one or two digits), or a non-unique number (a number with a large chance of being duplicated). While a SID comprising a unique number will inherently provide more security, the present invention is not so limited. Another embodiment of the invention comprises the central database providing presenters with SID suggestions if their entered SID is already registered within the system. These suggested SIDs are envisioned as SIDs that are not already registered in the system but are similar to the SID the presenter originally entered.

According to an alternate embodiment, a secondary ID number is utilized in the event that an individual does not remember their SID. In this embodiment, the secondary ID number is any number a registered individual registered during enrollment, such as, but not limited to, a home phone number, work phone number, social security number, birth date, or driver's license number.

If the embodiment of the system allows a presenter to register financial account information, that information is entered via magnetic stripe read, hand keying, or another input method. Checking account information is entered via a magnetic ink character recognition (MICR) read, an optical character recognition (OCR) read, hand keying, or via another method of input. The method of information input is also recorded for each enrollment. In an alternate embodiment, the system may be configured to take a digital image of the monetary-representative token the presenter normally uses to access the presented financial account and store this digital scan in the presenter's system record.

In an additional embodiment, a detailed history of the presenter's transactions may be stored in their system record and analyzed during a transaction. Storing and analyzing this information may enable the system to recognize the presenter's buying/accessing patterns for marketing and/or security purposes. Such marketing purposes include an unattended age verification station presenting purchase suggestions to the presenter during an age-restricted access transaction. For example, the age verification station might ask a presenter if they would like a pack of their regular cigarettes, and the information pertaining to their regular cigarettes is then obtained from the presenter's most purchased brand in their system history. In an additional embodiment, presenters may define their “regular” purchase by accessing their record through record maintenance functions.

Another marketing purpose includes up-selling an age-restricted purchase with either another restricted access or a non-restricted access. Up-selling an age-restricted purchase pertains to suggesting and/or offering an age-restricted purchase to a consumer while the consumer is conducting a separate transaction.

This embodiment provides presenter transaction history tracking, and from that history, the system knows that the presenter likes to purchase a specific brand of product, such as Marlboro Light cigarettes. As an example in such an embodiment, when the presenter presents their biometric for age verification to enter a night club, along with accepting or declining the presenter's age verification request, the system also reviews the presenter's purchase history to offer the presenter an up-sell. This up-sell may or may not be situation related, meaning the up-sell pitch the system makes to the presenter may or may not have anything to do with the time of day, the initial requested access, and/or the location of the initial requested access. If the presenter's transaction history indicates they like Marlboro Lights because, the presenter will be offered the opportunity to purchase a pack of Marlboro Lights. Up-selling a presenter during a non-age-restricted transaction may most likely occur at an unattended station which allows for biometric authentication of financial transactions. An example of this up-sell is a presenter using a biometrically authorized financial transaction system at a “pay-at-the-pump” gas station kiosk. Once the presenter enters their biometric to pay for their gas purchase, the system also reviews the presenter's purchase history to offer the presenter an up-sell. Again, the up-sell may or may not be situation related. If the presenter's transaction history indicates they like Marlboro Lights, the presenter will be offered the opportunity to purchase a pack of Marlboro Lights. In either up-sell embodiment case, should the presenter accept the up-sell offer, they may collect their cigarettes in various ways such as, retrieving them from an automated vending unit, retrieving them from a clerk by presenting their biometric again in a store affiliated with the age verification station, or presenting a printout generated by the age verification station to a clerk in a store affiliated with the age verification station.

Security purposes for maintaining a history of a presenter's transactions in the system include an unattended age verification station keeping track of a presenter's transactions within a specified time period and restricting the number of certain types of transactions allowed within that time period. For example, a presenter could only purchase two alcoholic drinks within the system in a 24 hour time period. Or, a presenter could only purchase one pack of cigarettes within a 24 hour time period. This feature may enable unattended age verification station operators and the system of the invention to avoid legal problems that might arise from Dram Shop Liability Laws. Additionally, this feature may help prevent presenters from making purchases at the unattended age verification station for their friends. Although the invention may be more secure with this presenter history tracking feature, it is not so limited.

Continuing with the enrollment process, after the presenter enrollment information is provided 202, the verifier enters confirmation that they have reviewed the presenter's entered information 204. To aid the security of the system, this confirmation is entered into the system by a verifier entering verifier identifying data, such as a biometric and/or ID number. In another embodiment the verifier may simply press a designated confirmation key or button on the enrollment device. Such verification allows the system to track verifier behavior within the system, so that if a verifier falls under suspicion of fraudulent verification activity, each enrollment the verifier has confirmed may be evaluated and presenter records verified by the verifier under suspicion may require re-verification. Additionally, such verifier confirmation of presenter-presented information helps discourage presenters from attempting to enroll in the system with false identification or false financial account information and helps discourage dishonest verifiers from confirming fraudulent presenter information.

After presenter data is entered and the verifier has verified the presenter's information, all data entered is transmitted to the central database 206 where it is stored 208. In an additional embodiment, other information may also be transmitted to the central database, such as but without limitation the time of day a presenter is enrolling and the enrollment device location. Depending on the embodiment of the invention, presenter information may be stored in the invention's central database, a verifier database, multiple verifier databases, or all of the above.

In an additional embodiment of the present invention, unattended age verification stations synchronously monitored by human verifiers may also be used for enrollment into the system. By way of illustration and not as a limitation, devices such as a vending machine, a PC, a kiosk, or a wireless device could comprise digital video capabilities, allowing a registered third party to monitor presenter enrollments into the system at a particular or at various unattended age verification stations. A registered third party might be any person verified with the system and with a device for viewing live, digital video and connections for receiving that digital video from at least one unattended age verification station. By way of illustration and not as a limitation, a certified third party may include an employee of a store close to the automated age verification station, an individual located in close proximity to the central database, or an individual remote from both the age verification station and the central database.

In yet an additional embodiment, the system offers asynchronous presenter enrollment into the system. For example, presenters may enroll into the system at unattended devices configured to collect enrollment information and save that information until a human verifier may review the enrollment information and verify the presenter's enrollment information. Once that presenter's enrollment information has been verified, the presenter can use their system record to verify their age at any participating device within the system of the invention. Such an embodiment could additionally provide the presenter with notice of whether or not their enrollment information has been reviewed and verified/not verified. This notice could be conducted via common methods of communication, such as email, telephone, fax, or mail.

Verifier synchronous or asynchronous witnessed enrollments may occur at any device equipped with biometric scanning capabilities. Non-biometric presenter information may either be scanned into the unattended device or typed into the device. However, systems wherein non-biometric presenter information is entered manually and not via a magnetic card read/scan are less secure than systems wherein a verifier witnesses or verifies the presenter's enrollment.

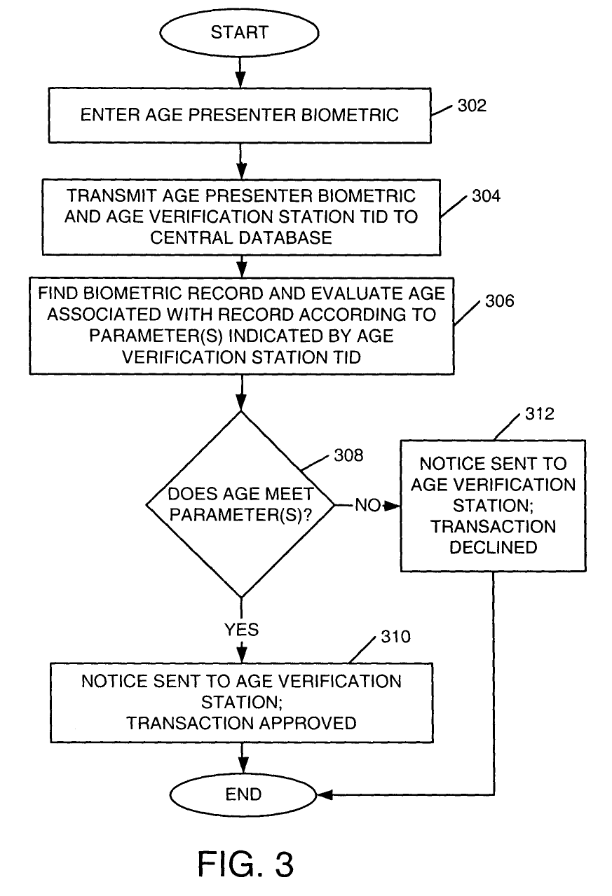

Referring to FIG. 3, a flowchart of an automated age-restricted transaction conducted at an unattended age verification station that provides access to products, services and/or areas that are governed by restrictions according to an embodiment of the present invention is illustrated. The presenter enters their biometric sample into the age verification station device 302. In an alternate embodiment, the presenter also enters SID that they registered with the system of the invention. Entering such a code may speed up and further secure the presenter record retrieval process. The presenter's biometric and the age verification station identification code (ID code) are sent to the central database 304. The presenter sample biometric is used to find the presenter's system record 306. Once the presenter's record is found, the age stored in the presenter's record is evaluated according to parameters indicated by the age verification station ID code 308. If the presenter's age meets the ID code indicated parameters, the transaction is approved and indication of transaction approval is sent to the age verification station 310. If, however, the presenter's age does not meet the ID code indicated parameters, the transaction is declined and indication of transaction decline is sent to the age verification station 312. In an additional embodiment, all age verification stations conduct transactions governed by the same age verification parameter(s). In such an embodiment, the presenter's age is verified according to system parameters stored in the database wherein the presenter's record is stored rather than evaluating the presenter's age by an unattended age verification station code or action proposal code. This embodiment negates the need for sending the age verification station ID from the age verification station to the database, thus reducing the amount of information required to be transferred from the age verification station to the database.

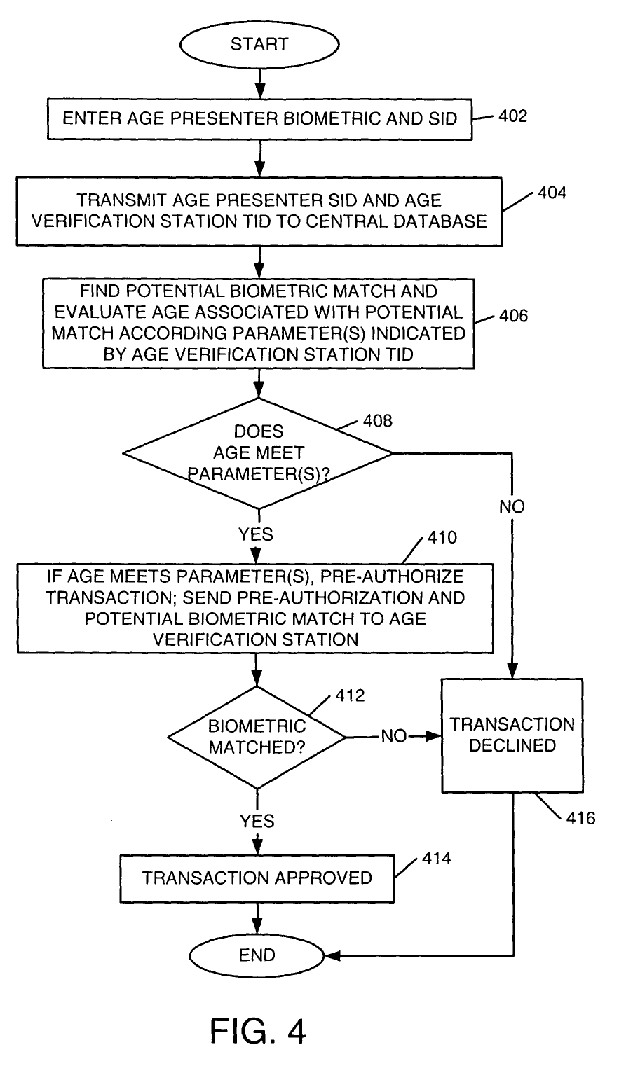

Referring to FIG. 4, a flowchart of an automated age-restricted transaction conducted at an unattended age verification station with biometric matching at the age verification station according to an embodiment of the present invention is illustrated. Such an embodiment provides access to products/services that are governed by the same age restriction. A presenter enters their biometric and their SID into the unattended age verification station 402. The presenter's SID is sent to the system's central database 404 where the presenter's SID is used to find potentially matching biometric records for the presenter's biometric sample entered in the age verification station 406. In an alternate embodiment, additional transaction information is transmitted from the age verification station to the central database including but not limited to age verification station ID code, transaction type, transaction reference number, a transaction time, terminal location, and presenter financial account selection information which the presenter's registered financial account they would like to use for purchasing the age-restricted goods/services. Potentially matching biometric records are found and the ages mapped to the biometrics are evaluated for transaction pre-approval according to the at least one system parameter 408. If an age mapped to a potentially matching biometric record meets the system parameter, then the biometric record is flagged for pre-approval and returned to the unattended age verification station for attempted match with the presenter biometric sample 410. If a potentially matching biometric matches the presenter's biometric sample 412 and the biometric record is flagged with a pre-approval, the presenter's age-restricted transaction is approved 414. If the record biometric does not match the presenter's biometric sample or if the record biometric is not flagged, the transaction is declined 416. In an additional embodiment, one age verification parameter is set for all age verification stations within the system of the invention. In such an embodiment, the presenter's-age is verified according to system parameters stored in the database wherein the presenter's record is stored. This embodiment negates the need for sending the age verification station ID code from the age verification station to the database.

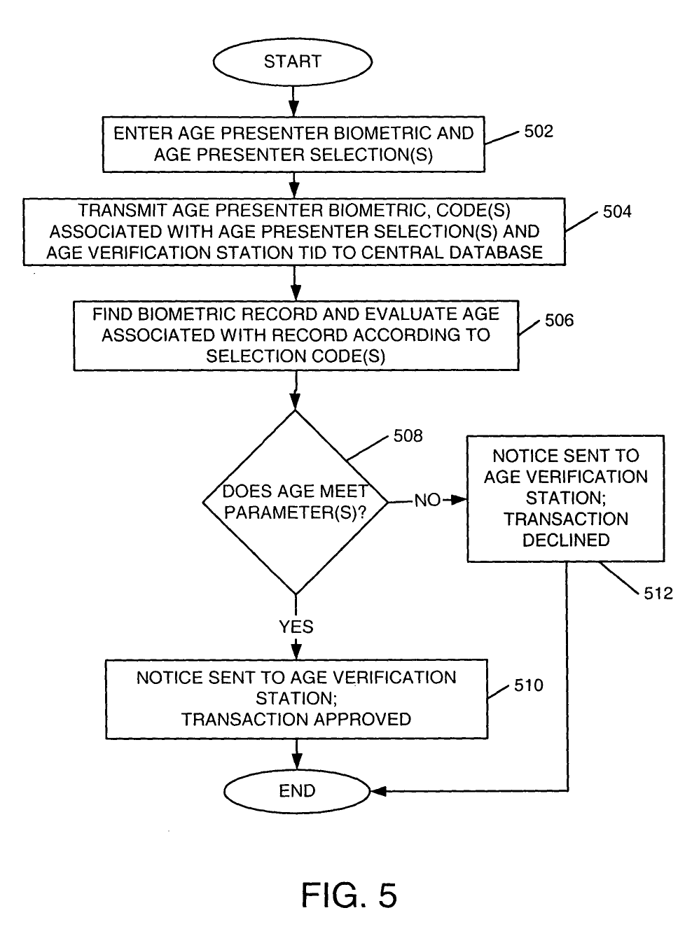

Referring to FIG. 5, a flowchart of an age-restricted transaction conducted at an unattended age verification station that provides access to products, services and/or areas that are governed by different age restrictions according to an embodiment of the present invention is illustrated. Such an embodiment allows for goods/services with either a single age restriction or varying age restrictions to be vended at the same age verification station or network of age verification stations. The presenter enters their biometric sample and at least one age-restricted action proposal 502. In an alternate embodiment, the presenter also enters a SID that they registered with the system of the invention. An age-restriction action proposal involves the presenter selecting an age-restricted action to perform at the unattended age verification station. A presenter makes an action proposal by one of various methods, such as pressing a button on one of the devices connected to the age verification station, selecting an image displayed on a touch screen display, or entering an alphanumeric code into a keypad on the device. An example of such an action proposal is a presenter entering a cigarette selection code at a cigarette vending device comprising an age verification station or a presenter pressing a button on a kiosk comprising an age verification station to gain entry into a nightclub.

Continuing with FIG. 5, the presenter biometric and the presenter action proposal are sent to the central database 504. In an alternate embodiment, additional transaction information is transmitted from the age verification station to the central database including but not limited to age verification station ID code, transaction type, transaction reference number, a transaction time, and station location. Additionally, in an embodiment of the invention which allows presenters to biometrically authorize financial transactions, the presenter's financial account selection information may also be sent from the age verification station to the central database. The presenter's age-restricted action proposal indicates the presenter's requested access, which in turn indicates the parameter(s) by which the presenter's age is evaluated.

The presenter's biometric record is found 506. If the presenter biometric sample and the presenter biometric record match, the age associated with the matching biometric record is evaluated. The age is evaluated according to the parameters indicated by the age-restricted action proposal(s) sent to the database 508. If the presenter's age is acceptable, the presenter's age is verified, the age-restricted transaction is approved, and the presenter is notified 510. However, if either the biometric data does not match or the age associated with a matching biometric does not meet age-restricted action proposal parameters, the age-restricted transaction is not approved and the presenter is notified of the decline 512.

If the presenter has selected more than one action within the system (e.g. purchase beer and purchase cigarettes), the age verification station sends the respective action proposal for each age-restricted item/service the presenter selects. During age verification, the presenter's age is evaluated according to the parameters associated with each action proposal. In such an embodiment, it is possible that the presenter age is approved for accessing certain goods, services and/or areas at the age verification station but not for accessing others. This embodiment allows presenters to perform age-restricted actions for which their age qualifies at an age verification station offering multiple age-restricted actions with varying age restrictions and allows various types of age-restricted actions to be offered at the same age verification station. By way of illustration and not as a limitation, a presenter might request access to an eighteen and older night club (action 1), purchase a pack of cigarettes (action 2), and pre-purchase a certain amount of beers for the night (action 3), all with one unattended age verification upon entry into the night club.

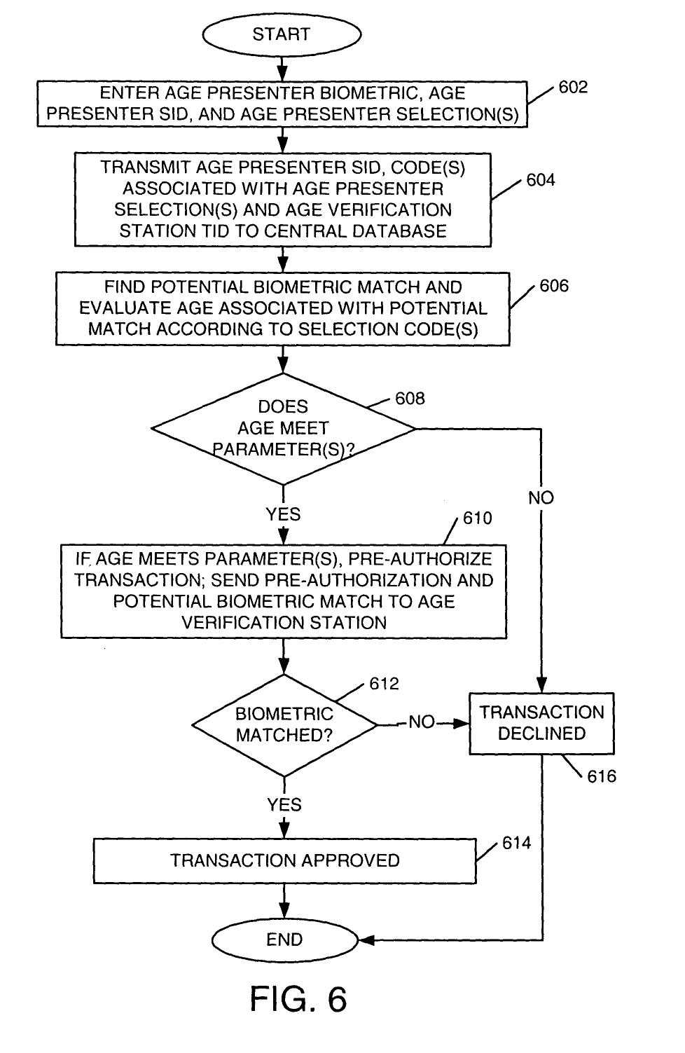

Referring to FIG. 6, a flowchart of an age-restricted transaction conducted at an unattended age verification station with biometric matching at the age verification station according to an embodiment of the present invention is illustrated. Such an embodiment allows for goods, services and/or areas with either a single age restriction or varying age restrictions to be vended at the same device or network of devices. The presenter enters their SID, their biometric sample, and their age-restricted action proposal(s) 602. The presenter's SID and action proposal(s) are sent to the central database 604. The presenter's SID is used to find the presenter's record. Once the presenter's record is found, the age associated with that record is evaluated according to the parameter(s) indicated by the action proposal(s) sent to the central database 606. If the associated age meets the indicated parameter(s), the desired age-restricted transaction is pre-authorized within the central database and the biometric held in the presenter's record is pulled and marked for transaction pre-approval 610. That biometric and pre-approval is then returned to the age verification station 610. The age verification station then determines whether or not the presenter's biometric sample matches the presenter's record biometric sample that was sent from the central database 612. If the presenter biometric sample and biometric record match, the transaction is approved and the presenter is notified 614. If the presenter biometric sample and biometric record do not match, the transaction is declined and the presenter is notified 616.

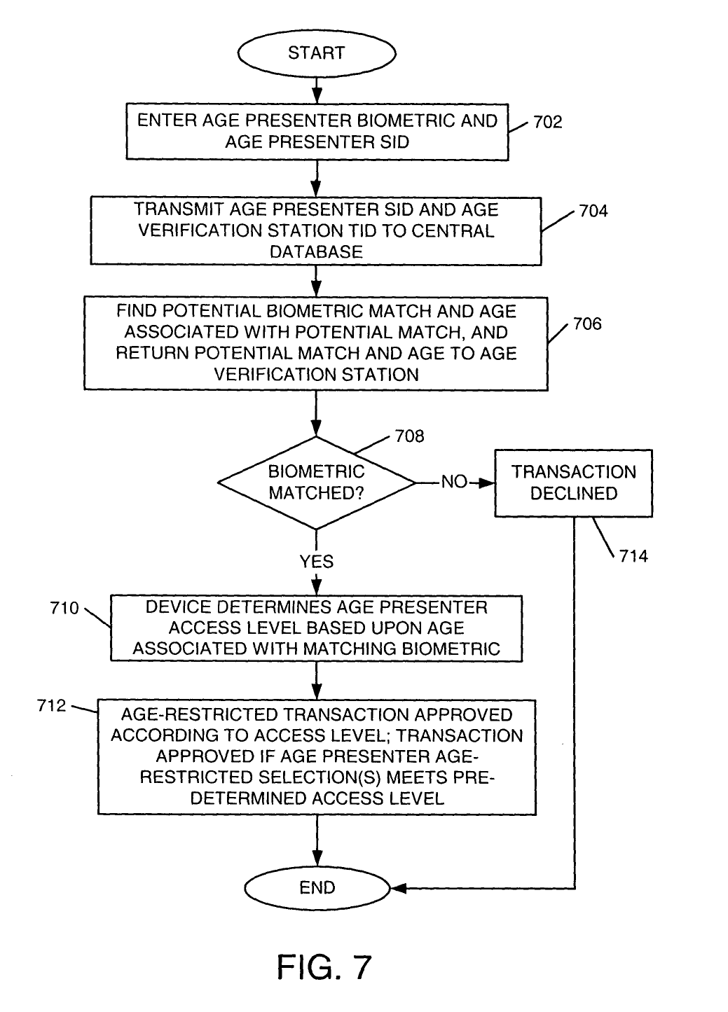

Referring to FIG. 7, a flowchart of an age-restricted transaction conducted at an unattended age verification station with biometric matching at the age verification station according to an embodiment of the present invention is illustrated. The presenter enters their biometric and SID 702. The presenter SID is sent to the central database 704. The central database finds at least one potential biometric match for the presenter's biometric sample, finds the age mapped to the potential biometric match, and returns the potentially matching biometric(s) and the associated age(s) to the age verification station 706. The age verification station determines whether or not the potentially matching biometric(s) returned from the central database matches the presenter's biometric sample 708. If a returned biometric record matches the presenter biometric sample, the age associated with that matching biometric is evaluated and the presenter is granted an age-restricted access level 710. The presenter makes their selection(s), and the transaction is approved if the presenter's selection(s) meets the pre-determined access level associated with their matching biometric record 712. If the presenter biometric sample does not match a biometric record returned from the central database, the age-restricted transaction is declined 714. Additionally, if the presenter attempts to access a product, service or area that is not allowed in their pre-determined access level, the transaction is declined.

In an alternate embodiment, additional transaction information is transmitted from the age verification station to the central database including but not limited to transaction type, transaction reference number, a transaction time, and terminal location. Presenter financial account selection information can also be transmitted to the central database in a system which comprises biometric authorization of financial transactions. In this embodiment, the financial account selection indicates the presenter's registered financial account they would like to use for purchasing the age-restricted goods/services. Additionally sending transaction time and/or location information to the central database may enable the system to more effectively incorporate county-specific and/or state-specific restrictions on selling age-restricted goods. A more specific example of other information that might be sent to the central database and used to further evaluate the transaction for approval or denial may be presenter blood alcohol information. By way of illustration and without limitation, an age-verification station might have connections to a blood alcohol testing device that prompts a presenter requesting access to purchase of alcoholic beverages to blow into the device. Results from that breathalyzer may then be transmitted to the central database. These results may be analyzed at either the age verification station or the central database. Such information might be used in the sale of alcohol to avoid vending alcohol to a presenter who is at over a set blood alcohol concentration limit. This limit may be set at the legal limit for operating a motor vehicle, may be set higher, or may be set lower, depending on various factors, such as but not limited to, where the age verification station is located and the time of day.

In an alternate embodiment of the invention, the system comprises utilizing an identification system as described in utility application Ser. No. 10/464,148, filed on Jun. 18, 2003 by Tim Robinson. Such an embodiment would allow a presenter to verify their identity and age in one system access. Additionally, such an embodiment would also provide a presenter record score which might be used to determine the degree of reliability of the presenter's identity and/or age verification.

An additional embodiment of the invention comprises encrypting information transferred between two points in the system. For purposes of example and without limitation, information may be encrypted at one point and sent across a non-secure connection between the points or not encrypted at a point of communication but sent to the other point of communication across a secure connection. Encryption and decryption of the messages may be monitored by services provided by a company such as VeriSign. As an added level of security, one alternate embodiment encrypts even information internal to a terminal and which is never transmitted in a communication. This prevents retrieval of sensitive information (e.g., data corresponding to a biometric scan) from a stolen terminal.

An additional feature of the present invention comprises allowing an individual enrolling in the system the ability to register a password that in conjunction with a registered SID would allow them to perform record maintenance of their system record over the Internet from a device without a BID.

An additional feature of the system allows direct transition from an enrollment into an age-restricted transaction without starting a new transaction should either enrollment or enrollment finalization occur at an unattended age verification station. This may allow a presenter to enroll into the system just before they verify their age or purchase an item without having to reenter their biometric.

According to another embodiment, all or select enrollment and identification methods comprise printing a paper receipt of the system activity performed during a system access. Information included on this receipt includes but is not limited to the transaction type, transaction date, transaction number, presenter record accessed, presenter financial account used for purchase, the invention's customer service phone number, instructions on how to contact the invention's customer service, or other transaction information.

It is also an alternate embodiment of the present invention to provide verifiers with presenter profile reports in case of suspected fraudulent activity. These reports may be customized to display select information from a presenter's age verifying record history.

In an additional embodiment, transactions within the system may be assigned a transaction number for reference in case of second communications between the age verification station and central database.

It will be appreciated by those skilled in the art that the system and method of the present invention can be used to perform more secure and reliable age verifications for age-restricted transactions at unattended age verification stations. Additionally, they system allows presenters to verify their identity and pay for age-restricted merchandise with the same biometric used to verify their age. It is anticipated that the present invention will especially find utility in preventing identity fraud in age verification situations wherein human supervision is not present. It will thus be appreciated by those skilled in the art that other variations of the present invention will be possible without departing from the scope of the invention as disclosed.

What is claimed is:

1. A method for providing approval of an age-restricted transaction conducted by an age presenter, comprising:
receiving, at an unattended age verification station, at least one biometric sample proffered by the age presenter via a biometric identification device;
sending the at least one biometric sample to at least one database, wherein the at least one database has at least one biometric record stored therein, wherein the at least one biometric record contains a reference of the age presenter's age;
comparing, at the at least one database, the at least one biometric sample to the at least one biometric record stored in the at least one database;
making a first determination, at the at least one database, whether the at least one biometric sample matches the at least one biometric record stored in the at least one database;
in the event the at least one biometric sample matches the at least one biometric record stored in the at least one database, making a second determination whether the age presenter's age information in the reference meets at least one system parameter;
in the event that the age mapped to the biometric record meets the at least one system parameter, approving the age-restricted transaction at the at least one database; and
receiving, at the unattended age verification station, confirmation of the age-restricted transaction approval.

2. The method of claim 1, wherein the at least one system parameter is defined by the age verification station.

3. The method of claim 1, wherein the at least one biometric sample comprises at least one of a fingerprint scan, an iris scan, a facial scan, a voice scan, a retinal scan, a hand architecture scan, a vein pattern scan, a signature sample, and a DNA sample.

4. The method of claim 1, wherein the at least one biometric record comprises at least one digital representation of a fingerprint scan, an iris scan, a facial scan, a voice scan, a retinal scan, a hand architecture scan, a vein pattern scan, a signature sample, and a DNA sample.

5. The method of claim 1, wherein the steps of sending and receiving comprise sending and receiving encrypted data.

6. The method of claim 1, wherein sending the at least one biometric sample to the at least one database further comprising sending at least one of a location for the unattended age verification station, a time of age-restricted transaction, a transaction type, a reference code, a detailed access record, and blood alcohol content of the age presenter.

7. The method of claim 1, wherein a system user's information is stored in the at least one database.

8. The method of claim 7, wherein transaction information pertaining to the age-restricted transaction is compared to the system user information stored in the at least one database.

9. The method of claim 1, wherein the unattended age verification station is selected from the group consisting of a vending machine, a kiosk, a PC, a wireless device, a computing device, and a storage device.

10. The method of claim 1, wherein the unattended age verification station is an unattended point of sale device.

11. The method of claim 10, wherein the age-restricted transaction comprises a financial transaction.

12. The method of claim 11, wherein the financial transaction settlement is conducted via a financial transaction system, wherein the financial transaction system comprises the at least one biometric sample being used to authenticate the financial transaction settlement.

13. The method of claim 12, further comprising prompting the age presenter to add an additional purchase selection to the transaction.

14. The method of claim 1, further comprising prompting the age presenter to add an additional age-restricted selection to the transaction.

15. The method of claim 1, wherein the second determination comprises a reliability determination and includes assessing whether or not the at least one biometric sample is being used fraudulently.

16. A method for providing approval of an age-restricted transaction conducted by an age presenter, comprising:
receiving, at an unattended age verification station, at least one biometric sample proffered by the age presenter via a biometric identification device;
receiving, at the unattended age verification station, at least one identification code proffered by the age presenter;
sending the identification code proffered by the age presenter from the unattended age verification station to at least one database; wherein the at least one database has at least one biometric record stored therein, wherein the at least one biometric record contains a reference of the age presenter's age, and wherein the at least one database has at least one identification code record;
comparing, at the at least one database, the at least one identification code to the at least one identification code record;
making, at the at least one database, a first determination whether the at least one identification code matches at least identification code record;
in the event the at least one identification code matches the at least one identification code record, making a second determination whether the reference meets at least one system parameter;
in the event the reference meets the at least one system parameter, pre-approving, at the at least one database, the at least one biometric record as a potential matching biometric record;
receiving, at the unattended age verification station, the potential matching biometric record from the at least one database;
comparing, at the unattended age verification station, the at least one biometric sample with the potential matching biometric record;
making, at the unattended age verification station, a third determination whether the at least one biometric sample matches the potential matching biometric record;
in the event that the at least one biometric sample matches the potential matching biometric record; making, at the unattended age verification station, a fourth determination whether the matching biometric record was pre-approved at the at least one database; and
in the event the matching biometric record was pre-approved at the at least one database, approving, at the unattended age verification station, the age-restricted transaction.

17. The method of claim 16, wherein the at least one system parameter is defined by the age verification station.

18. The method of claim 16, further comprising the age verification station sending to the at least one database confirmation of completion of the age-restricted transaction.

19. The method of claim 16, wherein the at least one biometric sample comprises at least one of a fingerprint scan, an iris scan, a facial scan, a voice scan, a retinal scan, a hand architecture scan, a vein pattern scan, a signature sample, and a DNA sample.

20. The method of claim 16, wherein the at least one biometric record comprises at least one digital representation of a fingerprint scan, an iris scan, a facial scan, a voice scan, a retinal scan, a hand architecture scan, a vein pattern scan, a signature sample, and a DNA sample.

21. The method of claim 16, wherein the at least one identification code,comprises at least one of a unique number, a reasonably unique number, and a non unique number.

22. The method of claim 16, wherein the steps of sending and receiving comprise sending and receiving encrypted data.

23. The method of claim 16, wherein sending the at least one biometric sample to the at least one database further comprising sending at least one of a location for the age unattended age verification station, a time of age-restricted transaction, a transaction type, a reference code, a detailed access record, and blood alcohol content of the age presenter.

24. The method of claim 16, wherein a system user information is stored in the at least one database.

25. The method of claim 24, wherein a transaction information pertaining to the age-restricted transaction is compared to the system user information stored in the at least one database.

26. The method of claim 16, wherein the unattended age verification station is selected from the group consisting of a vending machine, a kiosk, a PC, a wireless device, a computing device, and a storage device.

27. The method of claim 16, wherein the unattended age verification station is an unattended point of sale device.

28. The method of claim 27, wherein the age-restricted transaction comprises a financial transaction.

29. The method of claim 28, wherein the financial transaction settlement is conducted via a financial transaction system, wherein the financial transaction system comprises the at least one biometric sample being used to authenticate the financial transaction settlement.

30. The method of claim 16, further comprising prompting the age presenter for an additional transaction once the age-restricted transaction is completed.

31. The method of claim 16, wherein the second determination comprises a reliability determination and includes assessing whether or not the at least one biometric sample is being used fraudulently.

32. A method for providing approval of an age-restricted transaction conducted by an age presenter, comprising:
receiving, at an unattended age verification station, at least one biometric sample proffered by the age presenter via a biometric identification device;
receiving, at the unattended age verification station, at least one age-restricted action proposal proffered by the age presenter;
associating at least one proposal code with the at least one age-restricted action proposal;
sending the identification code proffered by the age presenter from the unattended age verification station to at least one database; wherein the at least one database has at least one biometric record stored therein, wherein the at least one biometric record contains a reference of the age presenter's age, and wherein the at least one database has at least one identification code record;
sending the at least one proposal code affiliated with the age-restricted action proposal proffered by the age presenter from the unattended age verification station to the database;
comparing, at the at least one database, the at least one biometric sample to the at least one biometric record;
making a first determination, at the at least one database, whether the biometric sample matches the at least one biometric record;
in the event the at least one biometric sample matches the at least one biometric record, making a second determination whether the reference meets a parameter, wherein the parameter is indicated by the at least one proposal code;
in the event the reference meets the parameter, approving the age-restricted transaction at the at least one database; and
receiving, at the unattended age verification station, confirmation of the age-restricted transaction approval.

33. The method of claim 32, wherein the age presenter proffers a plurality of the at least one age-restricted action proposals, wherein the plurality of age-restricted action proposals contain a plurality of age restrictions

34. The method of claim 32, wherein the at least one biometric sample comprises at least one of a fingerprint scan, an iris scan, a facial scan, a voice scan, a retinal scan, a hand architecture scan, a vein pattern scan, a signature sample, and a DNA sample.

35. The method of claim 32, wherein the at least one biometric record comprises at least one digital representation of a fingerprint scan, an iris scan, a facial scan, a voice scan, a retinal scan, a hand architecture scan, a vein pattern scan, a signature sample, and a DNA sample.

36. The method of claim 32, wherein the steps of sending and receiving comprise sending and receiving encrypted data.

37. The method of claim 32, wherein sending the at least one biometric sample to the at least one database further comprising sending at least one of a location for the age unattended age verification station, a time of age-restricted transaction, a transaction type, a reference code, a detailed access record, and blood alcohol content of the age presenter.

38. The method of claim 32, wherein a system user information is stored in the at least one database.

39. The method of claim 38, wherein a transaction information pertaining to the age-restricted transaction is compared to the system user information stored in the at least one database.

40. The method of claim 32, wherein the unattended age verification station is selected from the group consisting of a vending machine, a kiosk, a PC, a wireless device, a computing device, and a storage device.

41. The method of claim 32, wherein the unattended age verification station is an unattended point of sale device.

42. The method of claim 41, wherein the age-restricted transaction comprises a financial transaction.

43. The method of claim 42, wherein the financial transaction settlement is conducted via a financial transaction system, wherein the financial transaction system comprises the at least one biometric sample being used to authenticate the financial transaction settlement.

44. The method of claim 32, further comprising prompting the age presenter for an additional transaction once the age-restricted transaction is completed.

45. The method of claim 32, wherein the second determination comprises a reliability determination reliability determination includes assessing whether or not the at least one biometric sample is being used fraudulently.

46. A method for providing approval of an age-restricted transaction conducted by an age presenter, comprising:
receiving, at an unattended age verification station, at least one biometric sample proffered by the age presenter via a biometric identification device;
receiving, at the unattended age verification station, at least one identification code proffered by the age presenter;
receiving, at the unattended age verification station, at least one age-restricted action proposal proffered by the age presenter;
sending the identification code proffered by the age presenter from the unattended age verification station to at least one database; wherein the at least one database has at least one biometric record stored therein, wherein the at least one biometric record contains a reference of the age presenter's age, and wherein the at least one database has at least one identification code record;
associating at least one proposal code with the at least one age-restricted action proposal;
sending the at least one proposal code to the at least one database;
comparing, at the at least one database, the at least one identification code to the at least one identification code record;
making, at the database, a first determination whether the at least one identification code matches the at least one age presenter identification code;
in the event the at least one age presenter identification code matches the at least one age presenter identification code, making a second determination whether the reference meets at least one system parameter, wherein the at least one parameter is indicated by the at lest one proposal code;
in the at least one parameter is met, pre-approving, at the at least one database, the at least one biometric record as a potential matching biometric record for age verification approval at the unattended age verification station;
receiving, at the unattended age verification station, the potential matching biometric record;
comparing, at the unattended age verification station, the at least one biometric sample to the potential matching biometric record;
making, at the unattended age verification station, a third determination of whether the at least one biometric sample matches the potential matching biometric record;
in the event that the at least one biometric sample matches the potential matching biometric record; making, at the unattended age verification station, a fourth determination whether the matching biometric record was pre-approved at the at least one database; and
in the event the at least one biometric record was pre-approved at the at least one database, approving, at the unattended verification station, the age-restricted transaction.

47. The method of claim 46, wherein the age presenter proffers a plurality of the at least one age-restricted action proposals, wherein the plurality of age-restricted action proposals contain a plurality of age restrictions.

48. The method of claim 46, further comprising the age verification station sending to the at least one database confirmation of completion of the age-related transaction.

49. The method of claim 46, wherein the at least one biometric sample comprises at least one of a fingerprint scan, an iris scan, a facial scan, a voice scan, a retinal scan, a hand architecture scan, a vein pattern scan, a signature sample, and a DNA sample.

50. The method of claim 46, wherein the at least one biometric record comprises at least one digital representation of a fingerprint scan, an iris scan, a facial scan, a voice scan, a retinal scan, a hand architecture scan, a vein pattern scan, a signature sample, and a DNA sample.

51. The method of claim 46, wherein the steps of sending and receiving comprise sending and receiving encrypted data.

52. The method of claim 46, wherein sending the at least one biometric sample to the at least one database further comprising sending at least one of a location for the age unattended age verification station, a time of age-restricted transaction, a transaction type, a reference code, a detailed access record, and blood alcohol content of the age presenter.

53. The method of claim 46, wherein a system user information is stored in the at least one database.

54. The method of claim 53, wherein a transaction information pertaining to the age-restricted transaction is compared to the system user information stored in the at least one database.

55. The method of claim 46, wherein the unattended age verification station is selected from the group consisting of a vending machine, a kiosk, a PC, a wireless device, a computing device, and a storage device.

56. The method of claim 46, wherein the unattended age verification station is an unattended point of sale device.

57. The method of claim 56, wherein the age-restricted transaction comprises a financial transaction.

58. The method of claim 57, wherein the financial transaction settlement is conducted via a financial transaction system, wherein the financial transaction system comprises the at least one biometric sample being used to authenticate the financial transaction settlement.

59. The method of claim 46, wherein an unattended age verification station offers the age presenter an additional access in conjunction with the age-restricted transaction.

60. The method of claim 46, wherein the second determination comprises a reliability determination and includes assessing whether or not the at least one biometric sample is being used fraudulently.

61. A method for providing approval of an age-restricted transaction conducted by an age presenter, comprising:
receiving, at an unattended age verification station, at least one biometric sample proffered by the age presenter via a biometric identification device;
receiving, at the unattended age verification station, at least one identification code proffered by the age presenter;
sending the identification code proffered by the age presenter from the unattended age verification station to at least one database; wherein the at least one database has at least one biometric record stored therein, wherein the at least one biometric record contains a reference of the age presenter's age, and wherein the at least one database has at least one identification code record;
comparing, at the at least one database, the at least one identification code to the at least one identification code record;
making, at the at least one database, a first determination whether the at least one identification code matches at least identification code record;
in the event the at least one identification code matches the at least one identification code record, sending at least one biometric record to at the unattended age verification station;
receiving, at the unattended age verification station, the at least one biometric record with the reference;
comparing, at the unattended age verification station, the at least one biometric sample to the at least one biometric record;
making, at the unattended age verification station, a second determination of whether the at least one biometric sample matches the at least one biometric record;
in the event that the at least one biometric sample matches the at least one biometric record, making, at the unattended age verification station, a third determination of an access level that is associated with the reference; and
approving, at the unattended age verification station, an age-verification access level for the transaction.

62. The method of claim 61, further comprising the age verification station sending to the at least one database confirmation of completion of the age-related transaction.

63. The method of claim 61, wherein the at least one biometric sample comprises at least one of a fingerprint scan, an iris scan, a facial scan, a voice scan, a retinal scan, a hand architecture scan, a vein pattern scan, a signature sample, and a DNA sample.

64. The method of claim 61, wherein the at least one biometric record comprises at least one digital representation of a fingerprint scan, an iris scan, a facial scan, a voice scan, a retinal scan, a hand architecture scan, a vein pattern scan, a signature sample, and a DNA sample.

65. The method of claim 61, wherein the steps of sending and receiving comprise sending and receiving encrypted data.

66. The method of claim 61, wherein sending the at least one biometric sample to the at least one database further comprising sending at least one of a location for the age unattended age verification station, a time of age-restricted transaction, a transaction type, a reference code, a detailed access record, and blood alcohol content of the age presenter.

67. The method of claim 61, wherein a system user information is stored the at least one database.

68. The method of claim 67, wherein a transaction information pertaining to the age-restricted transaction is compared to the system user information stored in the at least one database.

69. The method of claim 68, wherein the unattended age verification station is selected from the group consisting of a vending machine, a kiosk, a PC, a wireless device, a computing device, and a storage device.

70. The method of claim 61, wherein the unattended age verification station is an unattended point of sale device.

71. The method of claim 70, wherein the age restricted transaction comprises a financial transaction.

72. The method of claim 71, wherein the financial transaction settlement is conducted via a financial transaction system, wherein the financial transaction system comprises the at least one biometric sample being used to authenticate the financial transaction settlement.

73. The method of claim 61, further comprising prompting the age presenter for an additional transaction once the age-restricted transaction is completed.

74. The method of claim 61, wherein the second determination comprises a reliability determination and includes assessing whether or not the at least one biometric sample is being used fraudulently.

75. A method for enrolling a system user in a transaction system comprising:
providing at least one unattended age verification station, wherein the least one unattended age verification station is configured to access at least one database, wherein the at least one database has at least one biometric record stored therein, wherein the at least one biometric record is associated with the system user and contains a reference of the age presenter's age;
prompting the system user to proffer an enrollment data comprising age information, personal information, and at least one biometric samples;
transmitting to the at least one database the enrollment data; and
storing in the at least one database the enrollment data.

76. The method of claim 75, wherein the method further comprises a system operator verifies the enrollment data.

77. The method of claim 76, wherein the system operator is remote from the system user.

78. The method of claim 76, wherein verification of the enrollment data is sent to the at least one database and stored in the at least one biometric record.

79. The method of claim 76, wherein verification comprises at least one of proffering a biometric scan, proffering an identification code, and pressing a designated key.

80. The method of claim 75, wherein the reference is a record of at least one of a government issued identification data, a driver's license data, a passport data, a birth certificate data, and a credit data.

81. The method of claim 75, wherein the enrollment data comprises at least one of a driver's license data, a social security number, an address, and a phone number.

82. The method of claim 75, wherein the enrollment data is acquired via a process selected from the group consisting of swiping, scanning and hand-keying.

83. The method of claim 75, wherein the at least one biometric sample is entered via a biometric scanner.

84. The method of claim 75, where in the at least one unattended age verification station is selected from the group consisting of a verifier station, a merchant's store, a government office, a bank, a kiosk, a vending machine, a personal computer and a wireless device.

85. The method of claim 75, wherein the system user additionally proffers an age presenter identification code.

86. The method of claim 85, wherein the age presenter identification code comprises at least one of a unique number and a reasonably unique number.

87. The method of claim 75, wherein the at least one biometric sample comprises at least one of a fingerprint scan, an iris scan, a facial scan, a voice scan, a retinal scan, and a hand architecture scan.

88. The method of claim 75, wherein the step of storing the enrollment data in the at least one database comprises:
converting the at least one biometric sample into a biometric template; and
saving the biometric template to the at least one database.

89. The method of claim 75, where in the enrollment data comprises a digital image of the at least one biometric sample.

90. The method of claim 75, wherein the enrollment data comprises a record maintenance password.

91. The method of claim 90, wherein the record maintenance password allows the system user to access and change the biometric record.

92. The method of claim 75, wherein the enrollment data comprises a digital image of at least one document presented for at least one of a system user identification and a system user age verification.

93. The method of claim 75, wherein the proffered enrollment data comprises financial account information.

94. A method for pre-enrolling a system user in a transaction system comprising:
providing at least one unattended age verification station, wherein the at least one unattended age verification station is configured to access at least one database, wherein the at least one database stores at least one biometric record, wherein the at least one biometric record is associated with the system user and wherein the biometric record has the capacity to contain a reference of the age of the system user:
prompting a system user to proffer an enrollment data, wherein the enrollment data is less than an amount of data needed for a complete enrollment;
transmitting to the at least one database the enrollment data; and
storing in the at least one database the enrollment data.

95. The method of claim 94, wherein the enrollment data comprises at least one of age verifying information, identity verifying information, and biometric information.

96. The method of claim 94, further comprising finalizing enrollment, wherein the system user proffers additional information not proffered during pre-enrollment, wherein the additional information is selected from the group consisting of age verifying information, identity verifying information, and biometric information.

97. The method of claim 96, wherein the enrollment data is verified by a system operator.

98. The method of claim 97, wherein verification of the enrollment data comprises at least one of proffering a biometric scan, proffering an identification code, and pressing a designated key.

99. A method for pre-enrolling a system user in a transaction system comprising:
providing at least one unattended age verification station, wherein the at least one unattended age verification station is configured to access at least one database, wherein the at least one database stores at least one biometric record, wherein the at least one biometric record is associated with the system user and wherein the biometric record has the capacity to contain a reference of the age of the system user:
prompting a database operator to proffer for the system user an enrollment data, wherein the enrollment data is less than an amount of data need for a complete enrollment;
transmitting to the at least one database the enrollment data; and
storing in the at least one database the enrollment data.

100. The method of claim 99, wherein the enrollment data comprises at least one of age verifying information, identity verifying information, and biometric information.

101. The method of claim 99, further comprising finalizing enrollment, wherein the system user proffers additional information not proffered during pre-enrollment, wherein the additional information is selected from the group consisting of age verifying information, identity verifying information, and biometric information.

102. The method of claim 101, wherein the enrollment data is verified by at least one of a system operator and database operator.

103. The method of claim 102, wherein verification of the enrolment data comprises at least one of proffering a biometric scan, proffering an identification code, and pressing a designated key.
